(19) United States
(12) Patent Application Publication
(10) Pub. No.: US 2006/0004951 A1
(43) Pub. Date: Jan. 5, 2006

(54) Method and apparatus to alter code in a memory

(76) Inventors: John C. Rudelic, Folsom, CA (US); Sujaya Srinivasan, Folsom, CA (US)

Correspondence Address: INTEL CORPORATION, P.O. BOX 5326, SANTA CLARA, CA, 95056-5326, US

(21) Appl. No.: 10/882,858

(22) Filed: Jun. 30, 2004

(51) Int. Cl. G06F 12/00

(52) U.S. Cl. 711/103; 711/202; 711/159

(57) ABSTRACT

Briefly, in accordance with an embodiment of the invention, a method and apparatus to alter code in a memory is provided. The method may include selecting a first block from a plurality of unmapped blocks in a nonvolatile memory to add or delete code in the nonvolatile memory. The apparatus may include a control circuit to select a first block from a plurality of unmapped blocks in a nonvolatile memory based on a cycle count of the first block to add or delete code in the nonvolatile memory. Other embodiments are described and claimed.

### BACKGROUND

Nonvolatile memories such as a flash electrically erasable programmable read-only memory (“flash EEPROM” or “flash memory”) may retain their data until the memory is erased. Electrical erasure of the flash memory may include erasing the contents of the memory of the device in one relatively rapid operation. The flash memory may then be programmed with new data or code.

The altering of code in a nonvolatile memory such as a flash memory may take a relatively long time. In a flash memory, this may be due to the amount of time it takes to perform an erase operation which affects the performance of the flash memory.

Thus, there is a continuing need for alternate ways to alter code in a flash memory.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a block diagram illustrating a portion of a computing system in accordance with an embodiment of the present invention; and

FIG. 2 is a block diagram illustrating a wireless device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

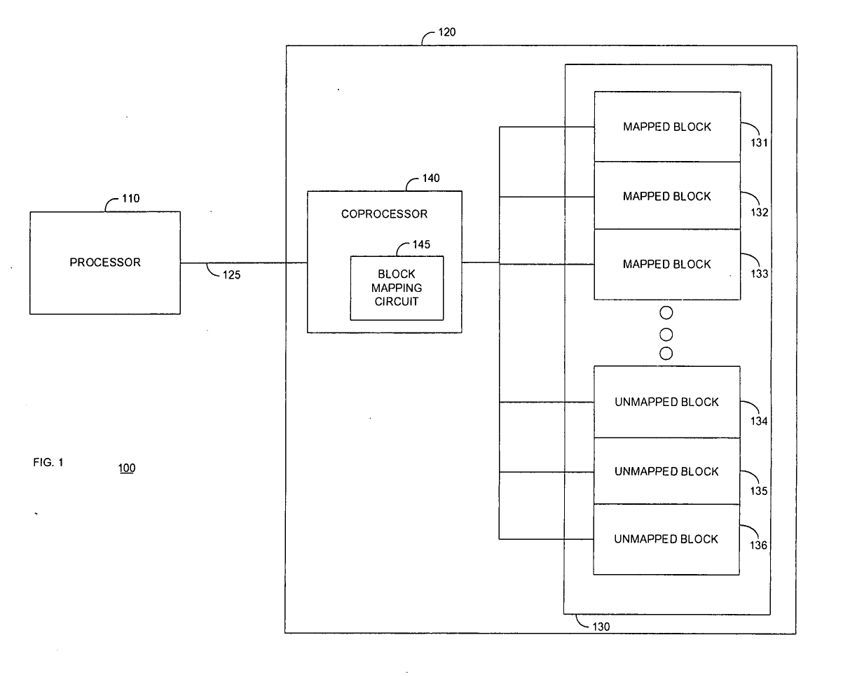

FIG. 1 is a block diagram illustrating a portion of a computing system 100 in accordance with an embodiment of the present invention. Although the scope of the present invention is not limited in this respect, system 100 may be used in a personal digital assistant (PDA), a wireless telephone (e.g., cordless or cellular phone), a pager, a digital music player, a laptop or desktop computer, a set-top box, a printer, etc.

System 100 may include a processor 110 and a nonvolatile memory 120 coupled to processor 110 via a bus 125. Although not shown, system 100 may include other components such as, for example, more processors, inpuvoutput (I/O) devices, memory devices, or storage devices. However, for simplicity these additional components have not been shown.

Processor 110 may include digital logic to execute software instructions and may also be referred to as a central processing unit (CPU). Software instructions may also be referred to as code. Although not shown, processor 110 may include a CPU core that may comprise an arithmetic-logic unit (ALU) and registers. Bus 125 may include one or more busses and may be a single 16-bit bus in one embodiment.

Nonvolatile memory 120 may be a NAND or NOR type of flash memory, and may be a single bit per cell or multiple bits per cell memory. Nonvolatile memory 120 may comprise one or more chips or integrated circuits (ICs). Although nonvolatile memory 120 is discussed as a flash memory, this is not a limitation of the present invention. In other embodiments, nonvolatile memory 120 may be another type of memory capable of storing data when power is removed from the memory. For example, nonvolatile memory 120 may be a ferroelectric random access memory (FRAM), a magnetic random access memory (MRAM), a disk memory such as, for example, an electromechanical hard disk, an optical disk, a magnetic disk, or any other nonvolatile device capable of storing code and/or data.

The term “information” may be used to refer to data, instructions, or code. Examples of data may include a serial number of a device or encryption keys. If system 100 is used in a wireless telephone, examples of data may include ring tone data or telephone number data. Examples of code may include a software application (e.g., a downloadable computer game), an operating system (O/S), a java applet, or libraries used by the operating system.

Nonvolatile memory 120 may store both code and data and may store code in one partition of memory 120 and may store data in another partition of memory 120. Each partition of nonvolatile memory 120 may comprise a plurality of blocks of memory, wherein each block includes a plurality of memory cells capable of storing at least one bit of information. The partition of nonvolatile memory 120 where data is stored may include one or more blocks and may be referred to as the data volume of nonvolatile memory 120. The partition of nonvolatile memory 120 where code is stored may include one or more blocks and may be referred to as the code volume of nonvolatile memory 120. In one embodiment, a block of memory may be 64 kilobytes (kbytes) in size and units of code, e.g., code objects stored in a block of memory, may vary in size. In one embodiment, memory 120 may include 128 blocks.

A code manager may be used to store and manage the code, e.g., code objects, in the code volume of nonvolatile memory 120. The code manager may be software or code that is stored in nonvolatile memory and may be executed directly from nonvolatile memory 120 without the intermediate step of loading the code to another memory device such as, for example, a volatile random access memory (RAM) device.

The code manager may be used to alter code in nonvolatile memory 120. For example, the code manager may be used to assist in adding code to, or deleting code from nonvolatile memory 120. In some applications, the code stored in nonvolatile memory 120 may be dynamic or alterable. For example, in cell phones, code stored in the nonvolatile memory of the cell phone may be updated or replaced by a user of the phone. The code manager may be used to perform the updating or replacing of code.

The code manager may store code contiguously in array 130 so that it can be directly accessed from nonvolatile memory 120, i.e., fetched and executed from nonvolatile memory 120 without the intermediate step of loading the code to a volatile RAM. This is sometimes referred to as execute-in-place (XIP) in some flash memories. By storing code contiguously in nonvolatile memory 120, pointer access may be provided so that processor 110 may directly access code stored in array 130.

In one embodiment, nonvolatile memory 120 may include an array 130 that includes a plurality of memory blocks. Array 130 may include a plurality of mapped blocks (e.g., 131-133) and a plurality of unmapped blocks (e.g., 134-136). Array 130 may be the code volume of nonvolatile memory 120 that is managed by the code manager.

Nonvolatile memory 120 may also include hardware and/or software that may be used to perform a “dynamic block swap” (DBS) function or mechanism that may perform wearleveling in nonvolatile memory 120 and improve access time performance of nonvolatile memory 120 for code management. For example, nonvolatile memory 120 may include a controller or coprocessor 140 that may include circuitry (e.g., block mapping circuit 145) and/or code (e.g., microcode or firmware) that may be used to perform DBS. Coprocessor 140 may be used to perform various control activities for memory 120. In one embodiment, coprocessor 140 may be an integrated processor of a multi-chip memory system.

The DBS may be used to increase performance of nonvolatile memory 120 by reducing the erase time as seen by processor 110. This may be accomplished by coprocessor 140 performing the erasing of blocks in the background, i.e., performing the erase operations after providing an indication to processor 110 that the operations of adding or deleting of code is complete. By having coprocessor 140 perform the erasing of blocks in the background, this may reduce the erase and reclaim times as seen by processor 110 or a user of system 100, and processor 110 may continue execution of code while the erasing or reclaim operations are being performed by coprocessor 140. In some flash memories, an erase operation may take at least one second to complete. However, in some embodiments, performing erase operations in the background may provide the perception to a user of system 100 that the erase operation occurs instantaneously. This may be referred to as zero second erase time.

In one embodiment, DBS may be a hardware assisted mechanism in memory 120, wherein all the blocks in array 130 may be initially unmapped and kept in a “ree pool” for use by the DBS. A block may be mapped or allocated to a certain physical address when the first write to write code to that address takes place, or when a request to allocate a block at a certain physical address occurs in the code volume. Block mapping circuit 145 may be used to map an unmapped block to a physical address. For example, coprocessor 140 may include block mapping circuit 145 to receive addressing information (e.g., a logical address) from processor 110 and may provide an address to array 120 (e.g., a physical address).

When an erase command is issued, the DBS mechanism may swap a dirty block (e.g., mapped block 131) to be erased with a clean block (e.g., unmapped block 134) from the free block pool, such that the erase appears instantaneous to processor 110 or to a user of system 100. The erase may be performed in the background by the hardware (e.g., coprocessor 140), and the erased block may be returned to the free block pool.

In one embodiment, an erase operation to delete code in array 130 may include receiving an erase command to erase a mapped block of memory 120 (e.g., mapped block 131) at a specified physical address; unmapping the mapped block to create a dirty unmapped block; selecting a clean unmapped block (e.g., unmapped block 134) from the plurality of unmapped blocks in memory 120 (e.g., unmapped blocks 134-136); mapping the clean unmapped block to the specified physical address to swap the mapped block (e.g., mapped block 131) for the clean unmapped block (e.g., unmapped block 0.134); and erasing the dirty unmapped block. The hardware of memory 120 may also maintain the erase cycle count of each block internally, and perform wearleveling by selecting a block from the free pool of clean unmapped blocks (e.g., unmapped blocks 134-136) based on an erase cycle count of the unmapped blocks. For example, to implement wearleveling, an erase operation to erase code in array 130 may include selecting a block from the free pool of clean unmapped blocks that has a relatively low erase cycle count.

A dirty block may refer to a mapped block that includes invalid data. In addition, a block that includes both invalid and valid data may be referred to as a dirty block. A clean block may refer to block that was previously erased and is available by the DBS mechanism for erase and reclaim operations. A reclaim operation may refer to an operation that reclaims unused space, e.g., dirty or invalid space, in memory 120. Some mapped memory blocks in the code volume may include both valid and invalid code. In order to reclaim the space used by the invalid code, a reclaim operation may include copying the valid code from the dirty block to a clean block and the dirty block may then be erased. As discussed below, a DBS may be used by a code manager to perform reclaim and erase operations.

The dynamic block swap (DBS) may be used by the code manager to speed up erase and reclaim operations performed to add or delete code to memory 120. The code manager may store code objects contiguously in a code volume, e.g., in array 130. When any code object is updated, replaced or deleted, a series of reclaim operations may need to be performed to coalesce all the free space (e.g., erased memory cells) in the code volume, so that free space does not get fragmented throughout the code volume. This may be advantageous so that a future code object allocation request, e.g., an over-the-air download of a software application resulting in the adding or deleting of code in the code volume, does not have to wait until completion of the one or more erase or reclaim operations that may be necessary to perform the code object allocation request.

In order to perform wearleveling and prevent the relatively high cycling of any block in the code volume, the DBS may maintain the erase cycle count for each block in the code volume. Then, when an erase operation occurs in response to the updating or deleting of code in a mapped block of array 130, the DBS may select an unmapped block from the plurality of unmapped blocks 134-136 based on the erase cycle count of the unmapped blocks. As may be appreciated, the erase operation may be part of reclaim operation. In one embodiment, to perform an erase or reclaim operation, the DBS may examine the erase cycle count of each of the plurality of unmapped blocks 134-136 of array 130; determine which unmapped block has the lowest erase cycle count; and then select the unmapped block having the lowest erase cycle count to perform the erase or reclaim operation. For example, the unmapped block may be mapped to the physical address of the mapped block targeted for erasing or reclaiming, and then the targeted block may be erased in the background by the DBS. After the targeted block is erased, it may be unmapped and made part of the pool of unmapped blocks available to the DBS for future code altering operations.

Managing the blocks of array 130 based on the erase cycle count and using the unmapped blocks with the least amount of erase cycle counts to perform erase and reclaim operations may distribute the erase cycles across the blocks of array 130. This process may be referred to as wearleveling.

In one embodiment, a reclaim operation to reclaim unused space in array 130 in response to the adding or deleting of code in array 130 may comprise selecting a clean unmapped block (e.g., 134) from the plurality of clean unmapped blocks (e.g., unmapped blocks 134-136) in array 130; copying valid code from a dirty mapped block (e.g., block 131) in array 130 to the selected clean unmapped block, wherein the dirty mapped block includes invalid code and valid code and wherein the dirty mapped block is mapped to a specified physical address; unmapping the dirty mapped block to create a dirty unmapped block; mapping the clean unmapped block to the specified physical address; and erasing the dirty unmapped block in the background.

In one embodiment, the DBS may also be used by the code manager to grow the code volume into a low-cycle count block of array 130. Growing the code volume may refer to any operation that increases the overall size of the code stored in memory 120 so that more mapped blocks are needed to store the code objects. As an example, when the code volume needs to be grown, e.g., when new code is added for storing in the code volume of memory 120, the DBS may allocate an unmapped block from the free pool of unmapped blocks to a particular physical address. The unmapped block that is allocated may be the one with the lowest cycle count to ensure wearleveling. The new code may be written to the unmapped back that has the lowest cycle count of the pool of clean unmapped blocks (e.g., 134-136). The code manager may map the unmapped block to a specific physical address so that the code is stored contiguously in the code volume and can be directly accessed by processor 110.

If unmapped, low-cycle count blocks were not used to grow the code volume, a mapped physical block that is adjacent to the code volume may be used to grow the code volume, however, the cycle count of this block may be relatively high. In addition, if the same mapped spare block were used to perform the erase or reclaim operations, then the spare block may achieve relatively high erase cycle counts and this may affect reliability of memory 120. Using the DBS to grow the code volume using relatively low erase cycle count, unmapped blocks may improve wearleveling and may improve performance if erase operations are performed in the background by memory 120.

Accordingly, as discussed above, the DBS implemented in memory 120 may perform wearleveling of the blocks of array 130 that are used to store code, mapping/unmapping of the blocks of array 130, and perform erase operations in the background.

As discussed above, in one embodiment, the present invention provides a method to alter code in a nonvolatile memory (e.g., nonvolatile memory 120), wherein the method comprises selecting a block of memory from a plurality of unmapped blocks in the nonvolatile memory to add or delete code in the nonvolatile memory. In another embodiment, the present invention provides a method to manage code in a nonvolatile memory (e.g., nonvolatile memory 120), wherein the method comprises selecting a block of memory from a plurality of blocks in the nonvolatile memory based on a cycle count of the selected block to add or delete code in the nonvolatile memory.

Further, in one embodiment, the present invention includes an apparatus comprising a memory control circuit (e.g., coprocessor 140) to select an unmapped block from a plurality of unmapped blocks (e.g., unmapped blocks 134-136) in a nonvolatile memory (e.g., memory 120) based on a cycle count of the unmapped block to add or delete code in the nonvolatile memory.

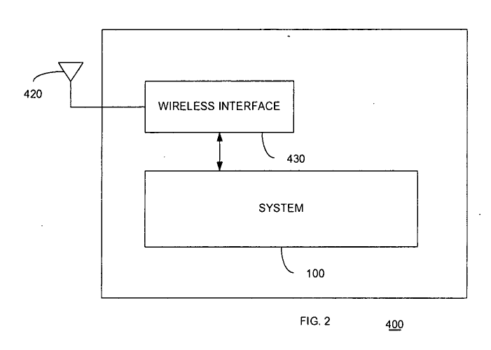

Turning to FIG. 2, shown is a block diagram illustrating a wireless device 400 in accordance with an embodiment of the present invention. In one embodiment, wireless device 400 may use the methods discussed above and may include computing system 100 (FIG. 1).

As is shown in FIG. 2, wireless device 400 may include an antenna 420 coupled to a processor (e.g., processor 110) of system 100 via a wireless interface 430. In various embodiments, antenna 420 may be a dipole antenna, helical antenna or another antenna adapted to wirelessly communicate information. Wireless interface 430 may be adapted to process radio frequency (RF) and baseband signals using wireless protocols and may include a wireless transceiver.

Wireless device 400 may be a personal digital assistant (PDA), a laptop or portable computer with wireless capability, a web tablet, a wireless telephone (e.g., cordless or cellular phone), a pager, an instant messaging device, a digital music player, a digital camera, or other devices that may be adapted to transmit and/or receive information wirelessly. Wireless device 400 may be used in any of the following systems: a wireless personal area network (WPAN) system, a wireless local area network (WLAN) system, a wireless metropolitan area network (WMAN) system, or a wireless wide area network (WWAN) system such as, for example, a cellular system.

An example of a WLAN system includes a system substantially based on an Industrial Electrical and Electronics Engineers (IEEE) 802.11 standard. An example of a WMAN system includes a system substantially based on an Industrial Electrical and Electronics Engineers (IEEE) 802.16 standard. An example of a WPAN system includes a system substantially based on the Bluetooth™ standard (Bluetooth is a registered trademark of the Bluetooth Special Interest Group). Another example of a WPAN system includes a system substantially based on an Industrial Electrical and Electronics Engineers (IEEE) 802.15 standard such as, for example, the IEEE 802.15.3a specification using ultrawideband (UWB) technology.

Examples of cellular systems include: Code Division Multiple Access (CDMA) cellular radiotelephone communication systems, Global System for Mobile Communications (GSM) cellular radiotelephone systems, Enhanced data for GSM Evolution (EDGE) systems, North American Digital Cellular (NADC) cellular radiotelephone systems, Time Division Multiple Access (TDMA) systems, Extended-TDMA (E-TDMA) cellular radiotelephone systems, GPRS, third generation (3G) systems like Wide-band CDMA (WCDMA), CDMA-2000, Universal Mobile Telecommunications System (UMTS), or the like.

Although computing system 100 is illustrated as being used in a wireless device in one embodiment, this is not a limitation of the present invention. In alternate embodiments system 100 may be used in non-wireless devices such as, for example, a server, a desktop, or an embedded device not adapted to wirelessly communicate information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
selecting a first block from a plurality of unmapped blocks in a nonvolatile memory to add or delete code in the nonvolatile memory.

2. The method of claim 1, further comprising mapping the first block to a physical address so that the code is stored contiguously in one or more blocks in the nonvolatile memory.

3. The method of claim 1, wherein selecting includes selecting the first block from the plurality of unmapped blocks in the nonvolatile memory based on an erase cycle count of the first block.

4. The method of claim 1, wherein selecting comprises:
examining a cycle count of each of the plurality of unmapped blocks; and
selecting the first block from the plurality of unmapped blocks if the first block has the lowest cycle count.

5. The method of claim 1, further comprising performing an erase operation to delete code in the nonvolatile memory, wherein the erase operation comprises the selecting the first block from the plurality of unmapped blocks.

6. The method of claim 5, wherein the erase operation further includes:
receiving an erase command to erase a mapped block in the nonvolatile memory at a specified physical address;
unmapping the mapped block to create a dirty unmapped block;
mapping the first block to the specified physical address; and
erasing the dirty unmapped block.

7. The method of claim 1, further comprising performing a reclaim operation to reclaim unused space in the nonvolatile memory in response to the adding or deleting of code in the nonvolatile memory, wherein the reclaim operation comprises the selecting the first block from the plurality of unmapped blocks.

8. The method of claim 7, wherein the reclaim operation further includes:
copying valid code from a dirty mapped block in the nonvolatile memory to the first block, wherein the dirty mapped block includes invalid code and valid code and wherein the dirty mapped block is mapped to a specified physical address;
unmapping the dirty mapped block to create a dirty unmapped block;
mapping the first block to the specified physical address; and
erasing the dirty unmapped block in the background.

9. The method of claim 1, further comprising adding new code to the nonvolatile memory, wherein adding new code comprises:
selecting the first block from the plurality of unmapped blocks if the first block has the lowest erase cycle count of the plurality of unmapped blocks;
writing the new code to the first block; and
mapping the first block to a physical address so that the new code is stored contiguously in the nonvolatile memory.

10. A method, comprising:
selecting a first block from a plurality of blocks in a nonvolatile memory based on a cycle count of the first block to add or delete code in the nonvolatile memory.

11. The method of claim 10, further comprising mapping the first block to a physical address so that the code is stored contiguously in one or more blocks in the nonvolatile memory.

12. The method of claim 10, wherein selecting comprises:
examining a cycle count of each of the plurality of blocks; and
selecting the first block from the plurality of blocks if the first block has the lowest cycle count.

13. An apparatus, comprising:
a control circuit to select a first block from a plurality of unmapped blocks in a nonvolatile memory based on a cycle count of the first block to add or delete code in the nonvolatile memory.

14. The apparatus of claim 13, wherein the control circuit is a coprocessor.

15. The apparatus of claim 13, wherein the control circuit is coupled to a memory array of the nonvolatile memory, the memory array includes the plurality of unmapped blocks, and the nonvolatile memory is a flash memory.

16. The apparatus of claim 15, wherein the flash memory includes a first partition that includes code and a second partition that includes data.

17. The apparatus of claim 16, wherein the control circuit includes a block mapping circuit to map the first block to a physical address so that the code is stored contiguously in one or more blocks in the nonvolatile memory.

18. The apparatus of claim 15, wherein each block of the flash memory includes a plurality of memory cells, wherein each memory cell is capable of storing at least one bit of information.

19. A system, comprising:
a control circuit to select a first block from a plurality of unmapped blocks in a nonvolatile memory based on a cycle count of the first block to add or delete code in the nonvolatile memory;
a processor coupled to the control circuit; and
an antenna coupled to the processor.

20. The system of claim 19, wherein the system is a wireless phone.

21. The apparatus of claim 19, wherein the control circuit is coupled to a memory array of the nonvolatile memory, the memory array includes the plurality of unmapped blocks, and the nonvolatile memory is a flash memory.
